(19) United States
(12) Patent Application Publication
(10) Pub. No.: US 2019/0391728 A1
(43) Pub. Date: Dec. 26, 2019

(54) SYNCHRONIZATION OF CONTENT BETWEEN A CLOUD STORE AND A PINNED OBJECT ON A MOBILE DEVICE

(71) Applicant: Microsoft Technology Licensing, LLC, Redmond, WA (US)

(72) Inventors: Abhijit Kumar Bairagi, Hyderabad (IN); Gopalakrishnan VENKATESWARAN, Hyderabad (IN); Amit DANGWAL, Hyderabad (IN); Ravi BIRHMAN, Hyderabad (IN); Sanjay Krupakar Bhat, Hyderabad (IN); Manish SETHI, Hyderabad (IN); Subodh KUMAR, Hyderabad (IN)

(21) Appl. No.: 16/015,927

(22) Filed: Jun. 22, 2018

(51) Int. Cl. G06F 3/0484; H04L 29/08

(52) U.S. Cl. CPC G06F 3/04845; G06F 3/04842; H04L 67/1097; H04L 67/1095

(57) ABSTRACT

A pinning service interaction agent receives a user input indicating an object, corresponding to an application, to be pinned to a selected mobile device screen. The agent receives user selection of content, that is stored in a document on a remote data store, to be displayed in the object. The agent intermittently receives refresh data refreshing the content displayed in the pinned object based on the content stored in the document on the remote data store.

### BACKGROUND

Computing systems are current in wide use. Some computing systems are cloud-based computing systems that host services. The services can take a wide variety of different forms. For instance, they can be services that are used to generate or author content, such as a word processing service, a spreadsheet service, a slide presentation service, among a wide variety of others.

Computing systems also include mobile devices. Users often use their mobile devices in order to access documents and other data that may be stored in the cloud. At times, there are certain types of data or content that is stored in the cloud, that a user may need to access often, and repeatedly, throughout a day.

Accessing cloud-based data in this way means that the mobile device must use a relatively large amount of computing overhead and bandwidth in establishing contact with the cloud computing system, launching or accessing an application so that a document can be accessed, and then opening the file (or document) to access the desired data. Often times, all of the content is then downloaded to the user's mobile device where it can be accessed by the user. Such data may also be accessed by a number of other users. Therefore, the user of the mobile device may wish to access it frequently, in order to determine whether it has been modified since the user last accessed it.

Mobile devices also include functionality which allows a user to select an object and “pin” it to a particular screen (such as the home screen) of the mobile device. For instance, the user can navigate through a user experience that allows the user to select an object corresponding to an application, or to another item, and pin that object to the user's home screen. The objects may display some type of static data (which is not updated without the user opening the underlying file or document), or a navigation link or icon that can be actuated by the user in order to navigate to some other functionality, such as to launch an application and open a document, to navigate to a particular website, etc.

The discussion above is merely provided for general background information and is not intended to be used as an aid in determining the scope of the claimed subject matter.

### SUMMARY

A pinning service interaction agent receives a user input indicating an object, corresponding to an application, to be pinned to a selected mobile device screen. The agent receives user selection of content, that is stored in a document on a remote data store, to be displayed in the object. The agent intermittently receives refresh data refreshing the content displayed in the pinned object based on the content stored in the document on the remote data store.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIG. 2 is a block diagram of one example of a pinning service computing system.

FIG. 3 is a block diagram of one example of a pinning service interaction agent.

FIGS. 4A and 4B (collectively referred to herein as FIG. 4) illustrate a flow diagram showing one example of the operation of the architecture illustrated in FIG. 1 in allowing a user to select cloud-based content for rendering on an object pinned to a home screen of a mobile device and to synchronize the content with the cloud-based content.

FIGS. 5A-9 show examples of user interface displays.

FIG. 10 is a block diagram showing one example of the architecture illustrated in FIG. 1 deployed in a cloud computing architecture.

FIGS. 11-13 show examples of mobile devices that can be used in the architectures shown in the previous FIGS.

FIG. 14 is a block diagram of one example of a computing environment that can be used in the architectures shown in the previous FIGS.

### DETAILED DESCRIPTION

As discussed in the background section, users often use their mobile devices in order to access data stored using an application, in a cloud-based data store. The users may frequently access that data throughout a day. Further, the frequently accessed data may be only a subset of the data contained in the document (such as a small part of a large spreadsheet document). This uses a substantial amount of computing system resources and bandwidth, and it also inhibits the user from performing other operations on the mobile device, such as answering calls, sending and receiving text messages, or other instant messages among other things.

The present description describes a system that allows a user to pin an object to a particular screen (such as the home screen) of his or her mobile device and to select content from a document that is to be displayed on the pinned object. The content is intermittently synchronized from a cloud-based data store so the pinned object shows a synchronized version of the selected content. The pinned object can also provide functionality so that the user can launch an underlying application from the pinned object and make modifications to the synchronized content. The modifications are merged and stored in the cloud-based data store.

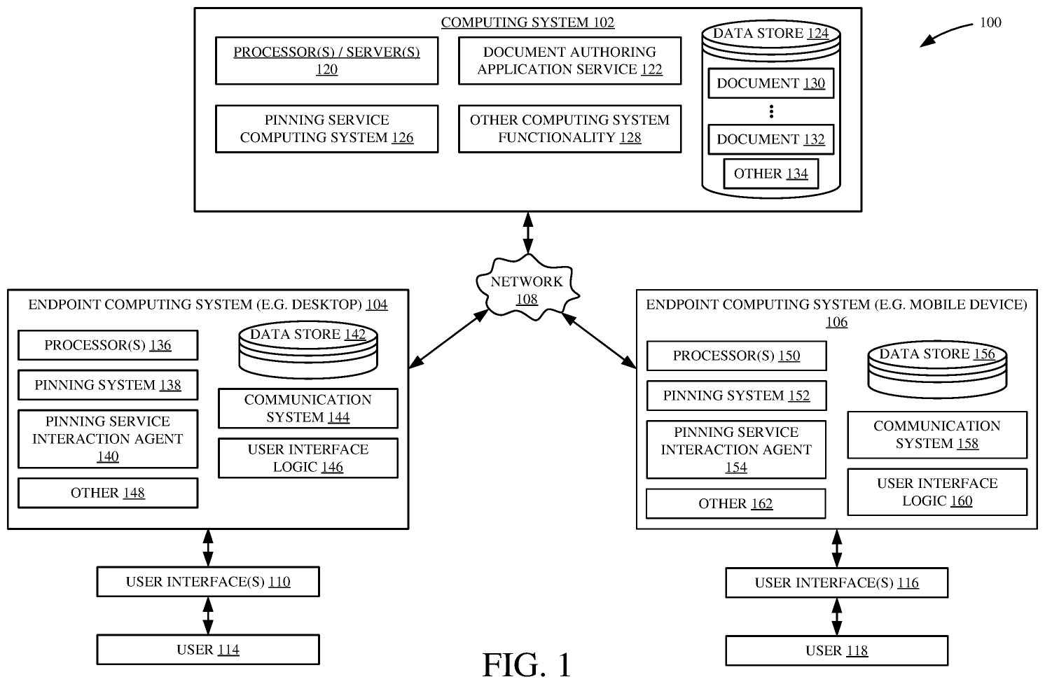

FIG. 1 is a block diagram showing one example of a computing environment 100. Environment 100 illustratively includes computing system 102 that is connected to end point computing systems 104 and 106 over network 108. Network 108 can be any of a wide variety of different types of networks, such as a wide area network, a local area network, a near field communication network, a cellular communication network, or a wide variety of other networks or combinations of networks.

In the example shown in FIG. 1, end point computing system 104 may be a client device, such as a desktop computer. End point computing system 106 is also a client device, such as mobile phone or smart phone, or other mobile device.

End point computing system 104 is shown generating user interfaces 110 for interaction by user 114. User 114 illustratively interacts with user interfaces 110 in order to control and manipulate computing system 104 and some parts of computing system 102. FIG. 1 also shows that mobile device 106 is generating user interfaces 116 for interaction by user 118. User 118 illustratively interacts with user interfaces 116 in order to control and manipulate mobile device 106 and some portions of computing system 102.

Before describing the overall operation of architecture 100 in more detail, a brief description of some of the items in architecture 100, and their operation, will first be provided. Computing system 102 illustratively includes one or more processors or servers 120, document authoring application service 122, document store 124, pinning service computing system 126, and it can include a wide variety of other computing system functionality 128. Document authoring application service 122 illustratively hosts a document authoring application which allows users 114 and 118 to author documents using service 122, and to store the documents in document store 124. Document store 124 is shown storing documents 130-132, but it can include other items 134 as well. The document authoring application service 122 can host a wide variety of different types of document authoring applications, such as a word processing application, a spreadsheet application, a slide presentation application, etc. Therefore, the documents stored in document store 124 can include spreadsheet documents, word processing documents, slide presentation documents, etc.

Service 122 illustratively has a front end that exposes an interface to the various end point computing systems 104-106 that access it in order to provide functional access to those end point computing systems so that their users can use the hosted application. Service 122 also illustratively includes a backend computing system that interacts with document store 124 in order to manipulate the documents 130-132 stored in document store 124 based upon user authoring inputs, create operations, read operations, update operations, delete operations, etc.

Pinning service computing system 126 illustratively receives an indication of a user input from one of the end point computing systems 104-106 indicating that the corresponding user wishes to have content from one of documents 130-132 displayed on an object that is pinned to a particular screen (such as the home screen) of the end point computing system. For purposes of the present description, it will be assumed that mobile device 106 is the end point computing system where the object and selected content will be displayed, on the home screen. It will be noted, however, that it could be displayed on either computing system 104 or 106. Further, in some examples, either one of the end point computing systems 104-106 can be used to pin an object on the home screen of the other computing system.

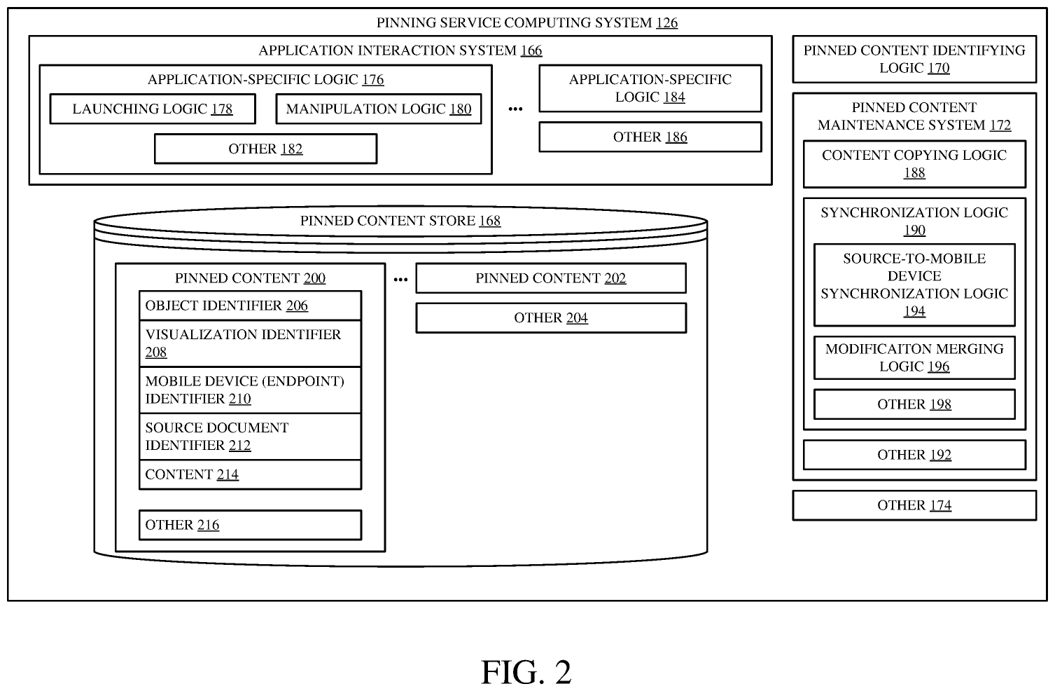

When pinning service computing system 126 receives an indication that a particular set of content is to be pinned to an object on the home screen of mobile device 106, it uses application-specific logic to access the particular document (e.g., document 130) to copy that content from document 130 onto pinning service computing system 126. It then intermittently synchronizes the content displayed on the pinned object on end point computing system 106 with the content in the selected document 130 in document store 124. Similarly, it may be that a user 118 modifies that content by interacting with the pinned object on mobile device 106. In that case, pinning service computing system 126 merges those modifications into the pinned content, and stores the modified content back in the corresponding document 130 in document store 124. All of this is described in more detail below with respect to FIGS. 2-4.

In the example shown in FIG. 1, end point computing system 104 can include one or more processors 136, pinning system 138, pinning service interaction agent 140, data store 142, communication system 144, user interface logic 146, and it can include a wide variety of other functionality 148. Similarly, mobile device 106 can include one or more processors 150, pinning system 152, pinning service interaction agent 154, data store 156, communication system 158, user interface logic 160, and it can include other items 162. End point computing systems 104 and 106 can operate similarly or differently. For purposes of the present description, it will be assumed that they are similar so that only a more detailed description of mobile device 106 will be undertaken at this point.

Communication system 158 illustratively allows mobile device 106 to communicate over network 108. Therefore, depending on the type of network that comprises network 108, communication system 158 is configured to allow communication over that type of network.

User interface logic 160 illustratively generates user interfaces 116 (either on its own or under the control of another item in mobile device 106) and can detect user interactions with those user interfaces. It can provide an indication of those user interactions to other items in mobile device 106 or other computing systems in FIG. 1.

Pinning system 152 illustratively includes functionality that allows user 118 to identify an application for which a corresponding object is to be pinned to a home screen of mobile device 106. Assume, for instance, that user 118 wishes to pin a spreadsheet object to his or her home screen. In that case, pinning system 150 illustratively exposes functionality through user interface 116 that allows user 118 to select the application (e.g., the spreadsheet application) and indicate that he or she wishes to have an object corresponding to the selected application pinned to his or her home screen. Agent 154 illustratively exposes functionality through user interfaces 116 to user 118 that allow user 118 to select a portion of a document (such as a subset of the content in a document) stored in document store 124, which is to be displayed on the pinned object that was selected using pinning system 152. Therefore, as is described in more detail below, agent 154 illustratively allows the user, through user interfaces 116, to select content from a document. It also interacts with pinning service computing system 126 to open the document 130 and display it to user 118 so that the user can select the particular content that the user wishes to have displayed on the pinned object. Agent 154 detects the user inputs selecting that content and provides an indication of that selection, using communication system 158, to pinning service computing system 126. It response, pinning service computing system 126 copies the selected content from document 130 into system 126 and intermittently synchronizes and maintains that content so that it is up-to-date both in document 130 and on the pinned object on mobile device 106.

FIG. 2 is a block diagram showing one example of pinning service computing system 126 in more detail. It is to be understood that the present description is provided in an example in which the data displayed on the pinned object is remotely stored. The present description is also intended to cover an example where the data is locally stored. In that case, some or all functionality of service computing system 126 can be performed by agent 154 on mobile device 106.

In the example shown in FIG. 2, pinning service computing system 126 illustratively includes application interaction system 166, pinned content store 168, pinned content identifying logic 170, pinned content maintenance system 172, and it can include a wide variety of other functionality 174. Application interaction system 166 illustratively includes different sets of application-specific logic 176 and 184. Each set can include application launching logic 178, application manipulation logic 180, and other functionality 182. System 166 can also include other items 186. Pinned content maintenance system 172 illustratively includes content copying logic 188, synchronization logic 190, and it can include other items 192. Synchronization logic 190 can include source-to-mobile device synchronization logic 194, modification merging logic 196, and it can include other items 198.

In the example shown in FIG. 2, pinned content store 168 illustratively includes a plurality of different pinned content records 200-202. It can include other items 204 as well. Each pinned content record 200-202 illustratively includes an object identifier 206 that identifies the particular object on the mobile device where the content is to be rendered. The pinned content record 200 can include a visualization identifier 208 that identifies the particular type of visualization through which the content is to be surfaced (such as bar chart, a pie chart, a table, text, etc.). The pinned content record 200 can include a mobile device (or other end point) identifier 210 that identifies the mobile device 106 where the content is to be displayed. It can include source document identifier 212 that identifies the particular source document 130-132 from which the content is to be obtained and to which it is to be synchronized. It can include a copy of the content 214 itself, and it can include other items 216.

The application interaction system 166 illustratively includes application specific logic 176-184 to interact with the different document authoring applications hosted by service 122. For instance, each item of application specific logic 126 can use the launching logic 178 to launch the application, if it is not already running. It can use the manipulation logic 180 to manipulate the application (such as to write information to a document, create a document, update or delete a document, etc.).

Pinned content identifying logic 170 illustratively receives an indication of user inputs from pinning service interaction agent 154 on mobile device 106 and determines which portion of content within a document (e.g., which portion of document 130) the user wishes to have displayed on the pinned object on mobile device 106. For instance, when application interaction system 166 has opened an application and allowed the user to select a file (e.g., document 130), and then receives an input indicating that the user has selected an object (such as a table, a chart, a range of grids or lines in a spreadsheet or word processing document), and provided an indication indicating that this is the content that the user wishes to have displayed on the pinned object, then pin content identifying logic 170 identifies the location of that content within the selected document 130, as the pinned content.

Content copying logic 188 then copies that content 214 into pinned content store 168 in a pinned content record 200. It also illustratively identifies the particular object on mobile device 106 that the content corresponds to and generates object identifier 206 identifying that object. It identifies, as the type of visualization through which the content will be displayed and generates visualization identifier 208 identifying the type of visualization. It identifies the mobile device or end point where it will be displayed and generates mobile device (end point) identifier 210 that identifies the particular mobile device where the content is to be displayed. It also generates a source document identifier 212 identifying the source document from which the content was copied.

Synchronization logic 190 then intermittently synchronizes that content between document 130 and the pinned object where the content is displayed on mobile device 106. In doing so, source-to-mobile device synchronization logic 194 synchronizes changes to document 130 on document store 124 down to the content 214 that is eventually displayed on the pinned object on mobile device 106. Modification merging logic 196 receives inputs indicative of modifications by user 118 to that content, through the pinned object, and merges those changes into document 130. In performing synchronization, either a push model or a pull model (or a hybrid model) can be used.

In the push model, synchronization logic 190 waits for another item to indicate that a change has been made. For instance, it may wait for a document authoring application service 122 to notify it that a change has been made to document 130. That will trigger synchronization with the content displayed on the pinned object on mobile device 106. In the pull model, synchronization logic 190 can intermittently provide a request to document authoring application service 122 requesting whether any changes have been made to that content portion of document 130 and, if so, synchronize the changes. In one example, modification merging logic 196 can use either model as well. For instance, it can receive an indication from pinning service interaction agent 154 that the user has modified the content displayed on the pinned object, and it can immediately merge those modifications and store them back to document 130. In another example, logic 196 can intermittently ask pinning service interaction agent 154 whether the user has made changes to the displayed content, and then merge those changes or modifications.

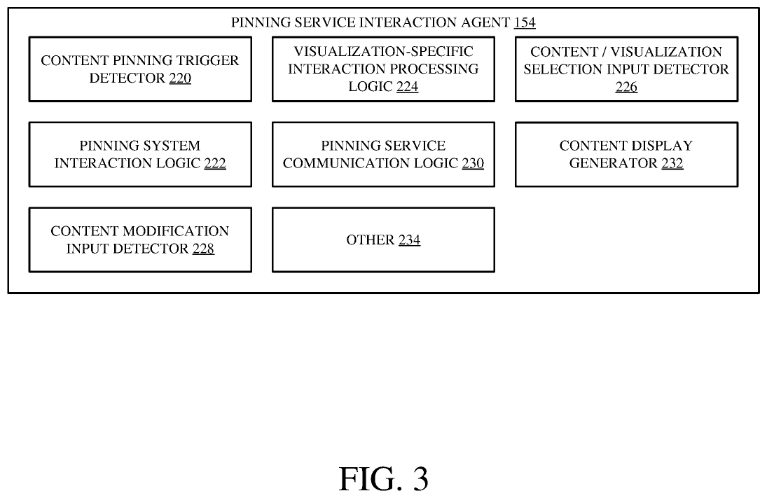

FIG. 3 is a block diagram showing one example of pinning service interaction agent 154, in more detail. In one example, agent 154 includes content pinning trigger detector 220, pinning system interaction logic 222, visualization-specific interaction processing logic 224, content/visualization selection input detector 226, content modification input detector 228, pinning service communication logic 230, content display generator 232, and it can include a wide variety of other items 234. Content pinning trigger detector 220 illustratively detects a user input indicating that the user wishes to have content displayed on a pinned object on the home screen of mobile device 106. Content/visualization selection input detector 226 illustratively displays a user input mechanism on an interface that allows user 118 to select the content that is to be displayed on the pinned object as well as the type of visualization that is to be used (such as a type of chart, a graph, a table, etc.). Pinning system interaction logic 222 then binds the selected data to the pinned object in pinning system 152 so that, when pinning system 152 displays the pinned object, it also displays the selected data. Pinning service communication logic 230 illustratively performs the communications with pinning service computing system 126. Therefore, if communication is performed in order to have user 118 view and select content in document 130, those communications are handled by logic 230. Content display generator 232 illustratively generates a display to display the selected content, using the selected visualization, on the object pinned to the home screen of mobile device 106. The generated display is then provided from generator 232 to user interface logic 160 on mobile device 106, which renders the display, showing the selected content on the pinned object.

Visualization-specific interaction processing logic 224 illustratively exposes, on a user interface 116, functionality that allows the user to perform visualization-specific interaction with the pinned object. For instance, if the content is displayed on the pinned object as a graph, then logic 224 allows the user to change the size of the units on the x and y axes on the graph. If the content is displayed as a bar chart, then logic 224 may allow user 118 to interact with the bar chart to zoom, pan, etc. The visualization-specific interaction processing logic 224 will expose different types of functionality, based upon the selected visualization in which the content is displayed on the pinned object.

Content modification input detector 228 detects a user input indicating that the user wishes to modify the content displayed on the pinned object. In that case, it illustratively uses pinning service communication logic 230 to communicate with pinning service computing system 126 to open the file where the content is synchronized from (e.g., to open document 130) and allow the user to modify the content, and then merge those modifications and save them back to document 130.

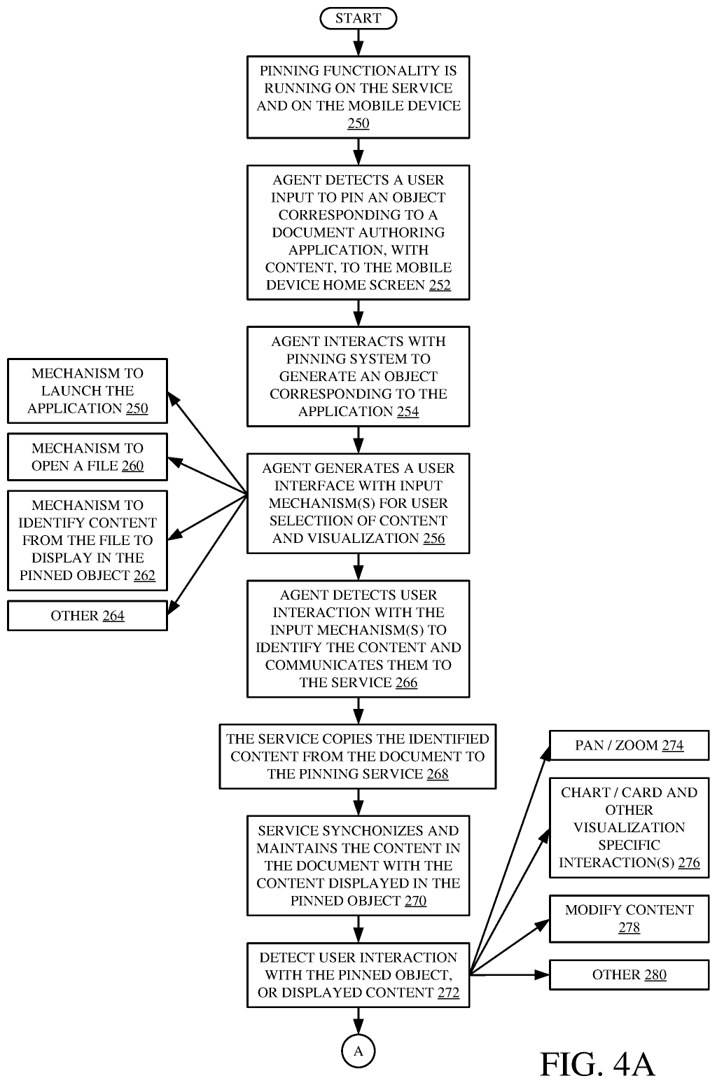

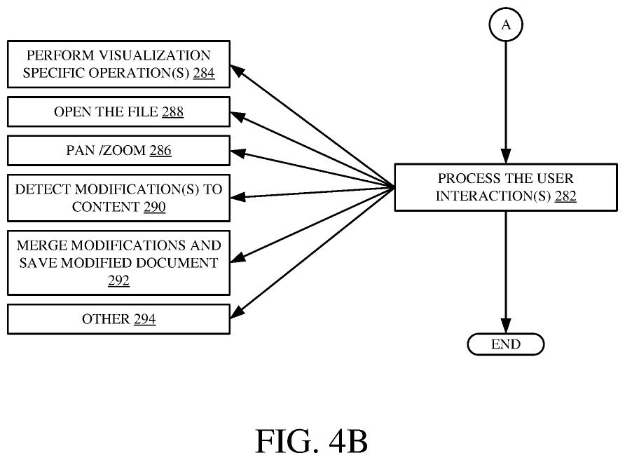

FIGS. 4A and 4B show a flow diagram illustrating one example of the operation of architecture 100 (including the operation of pinning service computing system 126 and pinning service interaction agent 154) in allowing a user to configure mobile device 106 to pin an object to the user's home screen and then to display selected content (that is stored in a remote document store 124) on the pinned object, and update or synchronize that data. It is first assumed that the pinning functionality is running on the service and on the mobile device. Therefore, it is assumed that pinning service computing system 126 and pinning service interaction agent 154 are running in the architecture. This is indicated by block 250 in the flow diagram of FIG. 4.

At some point, content pinning trigger detector 220 detects a user input indicating that the user wishes to pin an object corresponding to a document authoring application, with content, to the mobile device home screen. This is indicated by block 252. By way of example, the user may navigate to a settings screen, and select an application for which an object is to be generated and pinned to the home screen. The user may also provide an input indicating that the user wishes to have content from that document displayed on the object as well.

Pinning system interaction logic 222 then interacts with pinning system 152 to generate the object corresponding to the application, and to pin it to the home screen of the mobile device. This is indicated by block 254.

Content/visualization selection input detector 226 then generates a user interface display with input mechanisms that allow user 118 to select content from a particular file (or document), and a visualization with which that content will be surfaced on the pinned object. This is indicated by block 256. For instance, content/visualization selection input detector 226 can use pinning service communication logic 230 to surface a user input mechanism which can be actuated by user 118 in order to launch the underlying application, if it is not already running. This is indicated by block 258. A user input mechanism can also be provided that allows the user to open a file from which the content is to be obtained. This is indicated by block 260. A user input mechanism can be displayed that allows the user to identify the content, from the file, to display in the pinned object. This is indicated by block 262. For instance, the user input mechanism can allow the user to select a range of cells in a spreadsheet document, a range of rows or text in a word processing document, content from a slide presentation document, a table or chart in an underlying document, etc. The user interface can be generated with other mechanisms that allow the user to perform the selection of the content, and the particular type of visualization for displaying that content, in other ways as well. This is indicated by block 264.

Detector 226 then detects user interaction with those input mechanisms, selecting the content and the type of visualization, and uses pining service communication logic 230 to communicate that information to pinning service computing system 126 on computing system 102. This is indicated by block 266 on the flow diagram of FIG. 4.

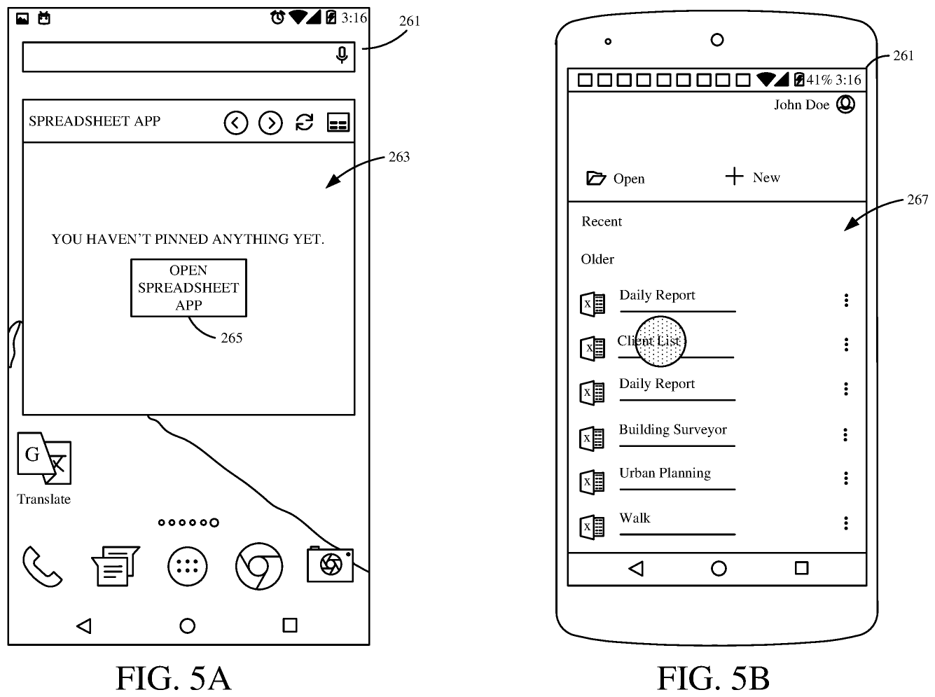

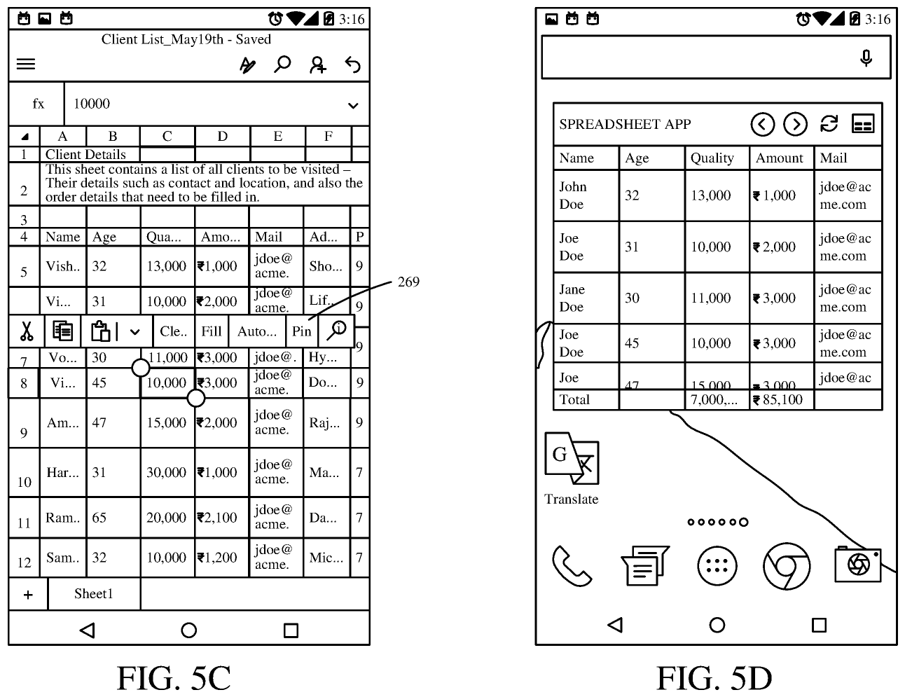

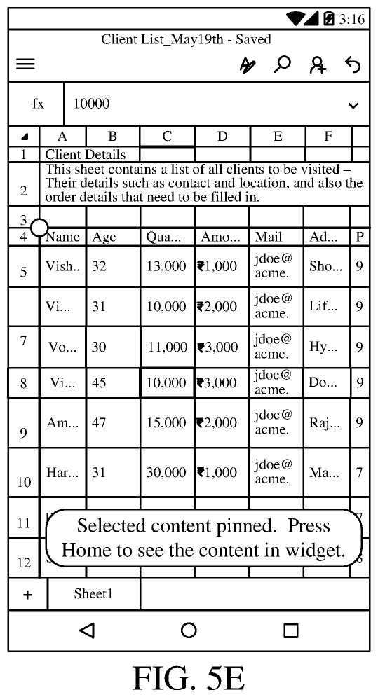

FIGS. 5A-9 show examples of user interfaces that can be generated in the architecture 100 illustrated in FIG. 1. For instance, FIG. 5A shows a mobile device 261(which can be the same as mobile device 106 shown in FIG. 1) that has a user interface display 263. User interface display 263 can be generated by agent 154 once the user has indicated that he or she wishes to pin an object, with content, to their home screen. User interface 263 includes a user input mechanism 265 that, when actuated, allows user 118 to open a spreadsheet application. This can be communicated to application interaction system 166 in pinning service computing system 126. Launching logic 178 then illustratively interacts with the application to open it.

The user may then be navigated to user interface display 267 in FIG. 5B where manipulation logic 180 interacts with the spreadsheet application to identify a list of files, or documents 130-132 that were authored using that application. User interface logic 160 detects a user selection of one of the files to be opened. Pinning service communication logic 230 communicates that back to application-specific logic 176 where manipulation logic 180 then opens the selected file. Once the file is opened, it is displayed such as shown in FIG. 5C. The user can then select a portion of the document that is displayed, as the content that is to rendered on the pinned object. The user can select the content, and then actuate the pin actuator 269, and content/visualization selection input detector 226 will communicate an indication of this to pinned content identifying logic 170 which identifies the selected content, in the open file, as the content to be rendered on the pinned object on mobile device 106. In response, content copying logic 188 copies that portion of the content from the open file and places it in a pinned content record 200 in pinned content store 168. This is indicated by block 268 in the flow diagram of FIG. 4.

Synchronization logic 190 then synchronizes (and maintains) the content in the document with the content displayed on the pinned object. This is indicated by block 270 in the flow diagram of FIG. 4. As mentioned above, source-to-mobile device synchronization logic 194 intermittently synchronizes the content from document 130 to the content displayed on the pinned object on mobile device 106. Modification merging logic 196 intermittently detects user modifications to that content, through the pinned object, and merges those changes into document 130. Content display generator 232 generates a display, such as that shown in FIG. 5D, of the selected control on the pinned object, wherein the user is viewing his or her home screen (or other screen to which the object has been pinned). In another example, generator 232 can display a verification that content has been pinned, as shown in FIG. 5E.

In another example, where the document is a spreadsheet application, the user may select a single cell, and a predefined range of cells, around the selected cell, will be included in the pinned content. The range may be modifiable by the user, or predefined. All of these and other architectures are contemplated herein.

It may also be that the user has already opened the application (such as the spreadsheet application) and only then decides to pin an object to his or her home screen corresponding to that application, and to select content for display on that object. In that case, the user may select the content, and then actuate pin actuator 269. The mobile device will then prompt the user to add an object corresponding to the underlying application and pin it to the home screen, so that the content can be rendered on that object. These and other example are contemplated herein.

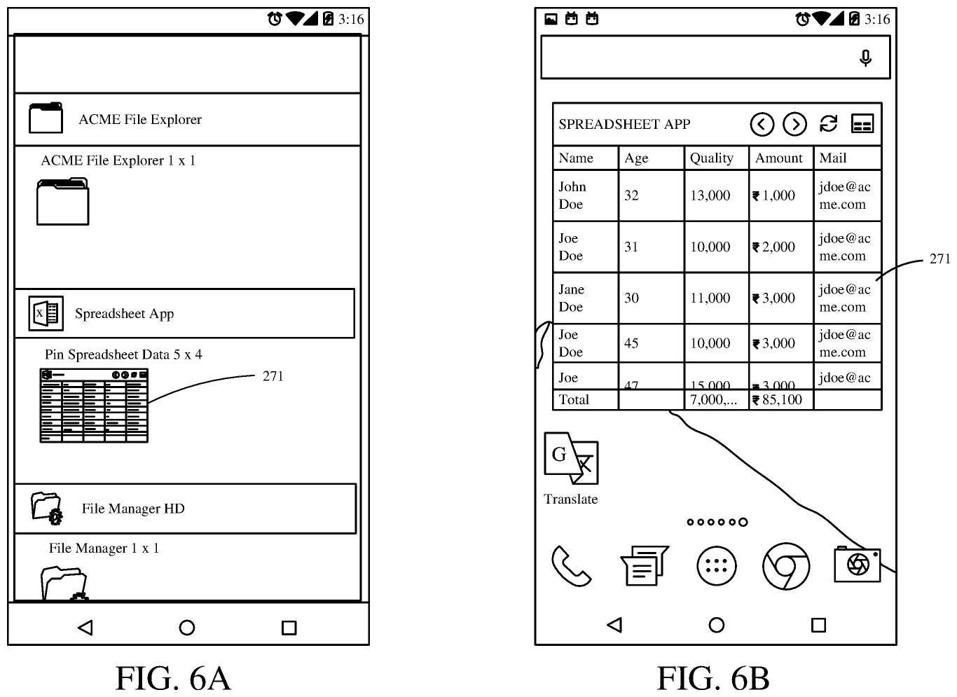

FIGS. 6A and 6B show two different examples of how the object can be displayed on the home screen of the user's mobile device 261. In FIG. 6A, the object 271 is displayed consuming less screen real estate then in FIG. 6B. In another example, when the user taps the object 271 shown in FIG. 6A, it can be rendered in a larger size, such as that shown in FIG. 6B.

Various items in pinning service interaction agent 154 use user interface logic 160 to detect user interactions with the pinned object, or the content displayed in the pinned object, and process those user interactions accordingly. Detecting the user interactions with the pinned object, or displayed content is indicated by block 272 in the flow diagram of FIG. 4. This can include visualization-specific interactions, such as pan and zoom interactions 274, chart/card or other visualization-specific interactions, indicated by block 276. It can also include content modification input detector 228 detecting a user interaction that modifies the displayed content in the pinned object. This is indicated by block 278. Other user interactions can be detected in other ways as well, and this is indicated by block 280.

Agent 154, and pinning service computing system 126 then process those user inputs. The place where they are processed depends on the type of user interactions. Processing the user interactions is indicated by block 282 in the flow diagram of FIG. 4. By way of example, if the user interactions are visualization-specific operations (such as interactions with a chart, interactions with a graph, interactions with a table, etc.), then those visualization-specific operations can be performed by agent 154 on mobile device 106 using visualization-specific interaction processing logic 224. This is indicated by block 284. The same is true of pan and zoom operations. For instance, it may be that the visualization allows the user to zoom in on the content, or to pan or scroll through the content. In that case, visualization-specific interaction processing logic 224 performs the pan and zoom operations. This is indicated by block 286 in FIG. 4.

It may be, however, that the user interactions indicate interactions with the file or the content itself. In that case, then those user interactions are provided to pinning service computing system 126 which uses the application-specific logic in application interaction system 166 to interact with authoring application 122 to perform the operations. For instance, if the user wishes to modify the content displayed in the pinned object, then manipulation logic 180 opens the file 130 so that the content can be modified. This is indicated by block 288. Content modification input detector 228 then detects user modifications to the content, and provides an output indicative of those modifications to modification merging logic 196 in pinning service computing system 126. Logic 196 then merges those modifications with the underlying document 130. Detecting modifications to the content and merging the modifications and saving them to the underlying document are indicated by blocks 290 and 292 in the flow diagram of FIG. 4. The user interactions can include a wide variety of other user interactions that are processed in a wide variety of other ways as well, and this is indicated by block 294 in the flow diagram of FIG. 4.

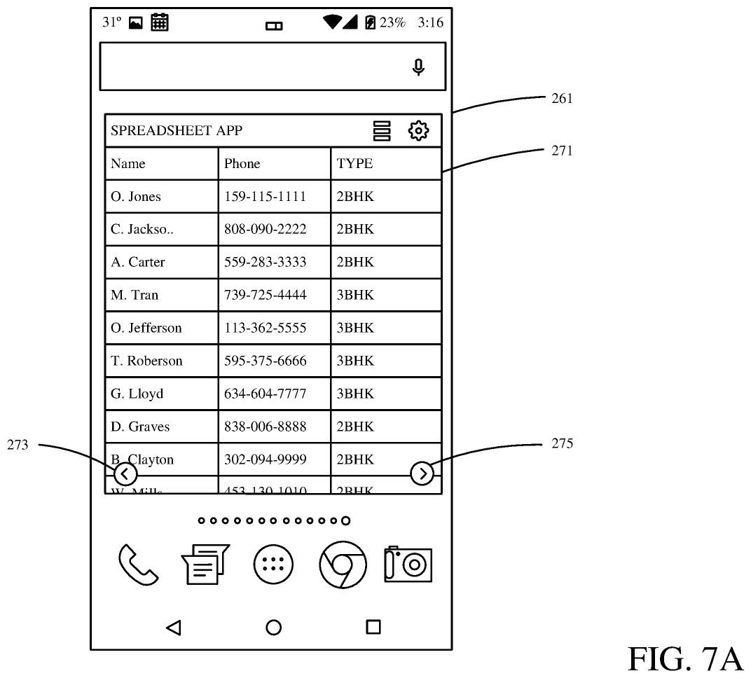

Referring again to FIG. 6B, in one example, the user can scroll the content on the object 271, vertically, by providing an appropriate touch gesture, such as a vertical swipe gesture. Also, the user may be able to pan the content horizontally by actuating a pan actuator. The pan actuator can be provided and controlled by visualization-specific interaction processing logic 224. FIG. 7A shows one example of this. In FIG. 7A, the object 271 is shown with a set of horizontal panning actuators 273 and 275. When the user actuates either of these actuators, logic 224 illustratively pans the content on the object 271 horizontally so that the user can see the full range of content that is bound to the pinned object.

The user may be able to refresh the content displayed on the object in a number of different ways. In one example, the user simply taps on the object 271 and pinning service communication logic 230 communicates an indication of this to synchronization logic 190. Synchronization logic 190 then refreshes the content 214 in the pinned content record 200 and also sends that refreshed content to mobile device 106, where content display generator 232 displays it on the pinned object. In another example, a separate refresh actuator may be displayed on the pinned object. When that actuator is actuated by the user, the content may be refreshed.

Content modification input detector 228 also detects when the user interacts with the object 271 indicating a desire to open the underlying file and make modifications to it. This can be done by providing an appropriate touch gesture (such as touch and hold, double tap, etc.) or by providing an actuator that can be actuated to open the file. Content modification input detector 228 detects any inputs modifying the content of the file, and when the user closes the application, it uses pinning service communication logic 230 to send the last saved state of the content to pinning service computing system 126 so that it can save that content to the pinned content record 200 and underlying document 130.

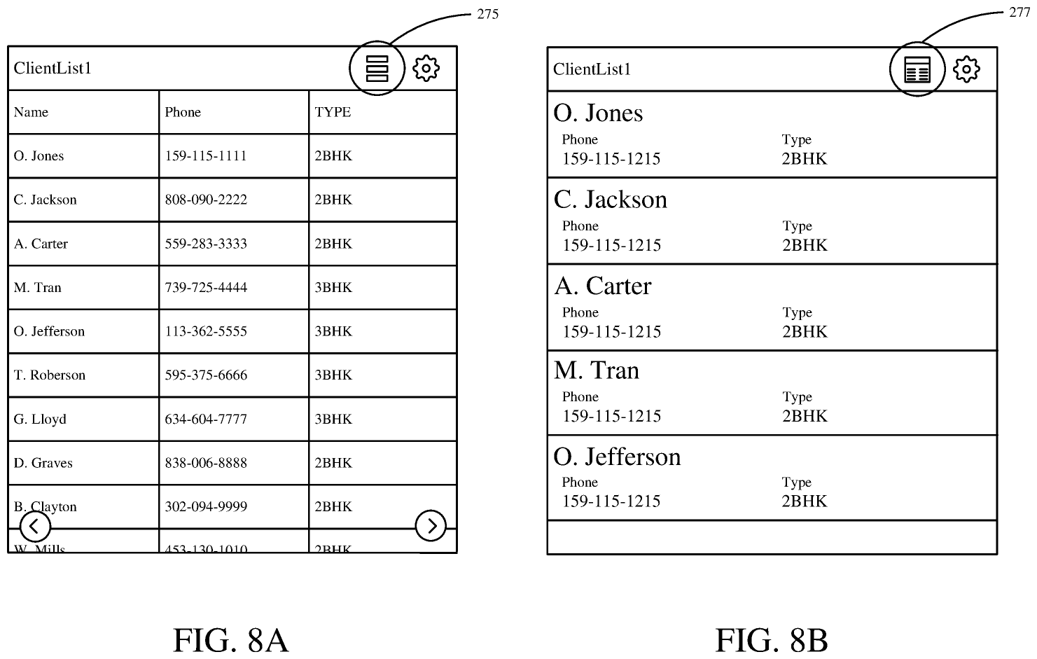

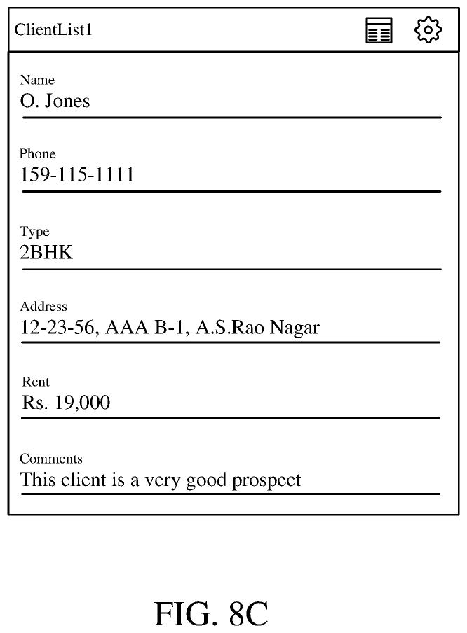

Content/visualization selection input detector 226 can provide a number of different mechanisms that the user can actuate in order to select the type of visualization that is to be used to render the content on the pinned object. For example, FIG. 8A shows that content is rendered in a grid view. Also, however, a “deck of cards” actuator 275 is displayed. When the user actuates the deck of cards actuator 275, content/visualization input detector 226 detects this and converts the three columns in the grid view into a card view as shown in FIG. 8B. Also, detector 228 uses content display generator 232 to display a grid view actuator 277 that can be actuated to convert the visualization back to a grid view.

In one example, the user can tap on any one of the cards in the deck shown in FIG. 8B, and the full card content will be displayed. In that case, pinning service communication logic 230 can communicate the user interaction to application interaction system 166 which launches the underlying application, opens the file, and retrieves the information for the full card view. One example of a full card view is shown in FIG. 8C.

Visualization-specific interaction processing logic 224 processes the functionality and user inputs corresponding to both the grid view, and the card view, as this functionality is specific to the type of visualization that was generated.

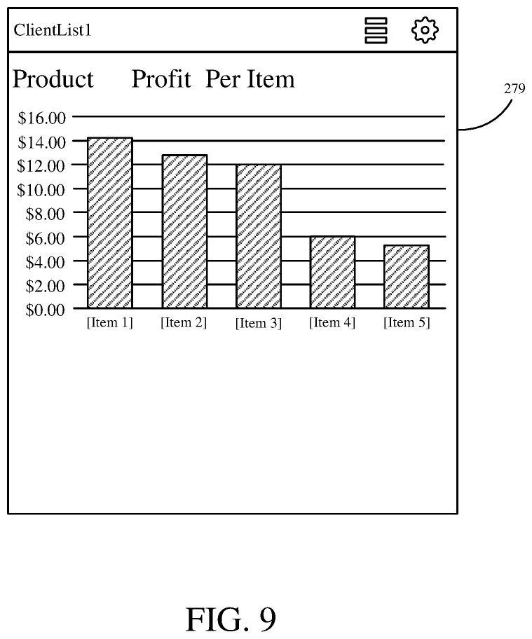

FIG. 9 shows that the user can also select a different visualization. For instance, the user can select a chart visualization such as chart 279 shown in FIG. 9. The chart can be selected in the underlying document 130, or content can be selected, and a chart visualization can also be selected so that the content is displayed as a chart. Visualization-specific interaction processing logic 224 then detects any user inputs on chart 279 and performs the desired visualization-specific processing. For instance, it may be that a chart allows the user to pan, scroll and zoom. In that case, the corresponding user inputs are detected and the functions are performed by visualization-specific interaction processing logic 224.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

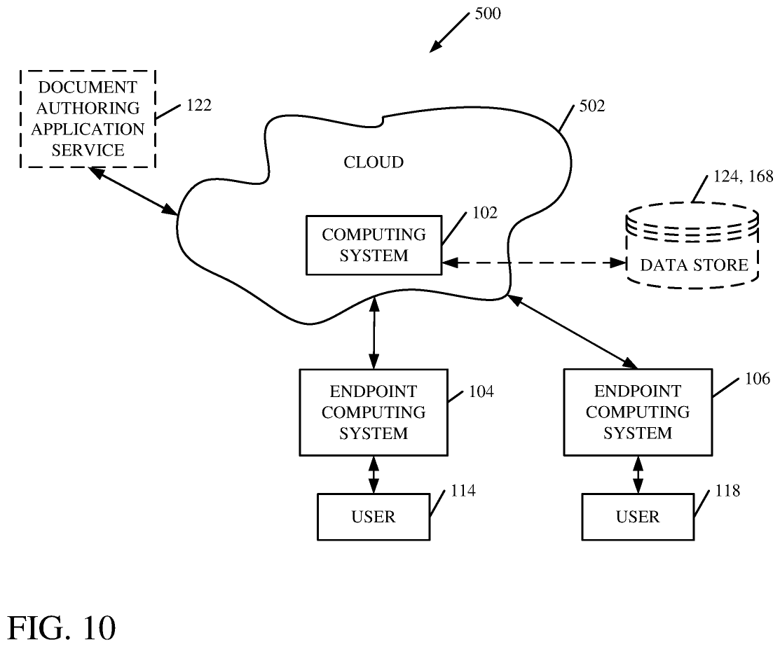

FIG. 10 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 10, some items are similar to those shown in FIG. 1 and they are similarly numbered. FIG. 10 specifically shows that computing system 102 is located in cloud 502 (which can be public, private, or a combination where portions are public while others are private). Therefore, user 114 and 118 use computing system 104 and 106 to access those systems through cloud 502.

FIG. 10 also depicts another example of a cloud architecture. FIG. 10 shows that it is also contemplated that some elements of computing system 102 can be in cloud 502 while others are not. By way of example, data store 124 can be disposed outside of cloud 502, and accessed through cloud 502. In another example 168 document authoring application service 122 (or other items) can also be outside of cloud 502. Regardless of where they are located, they can be accessed directly by systems 104-106, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

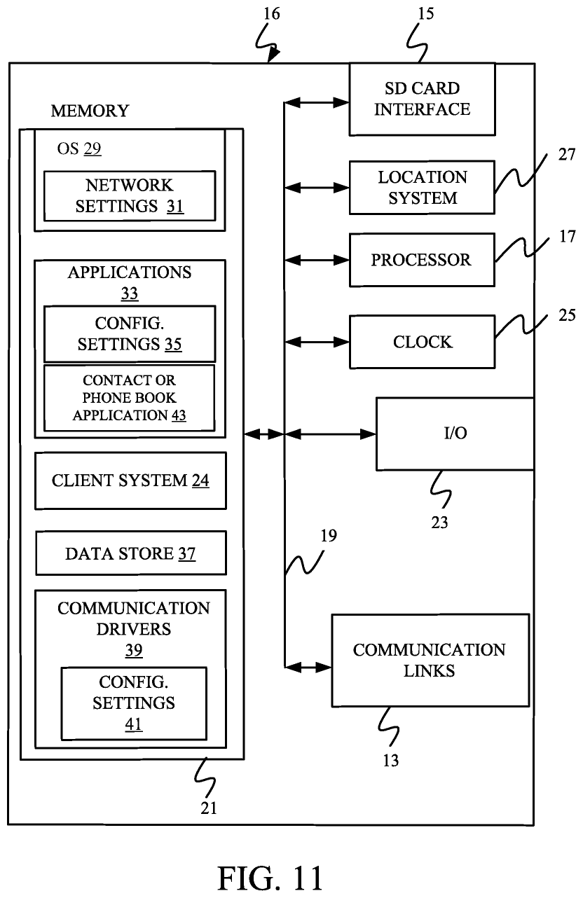

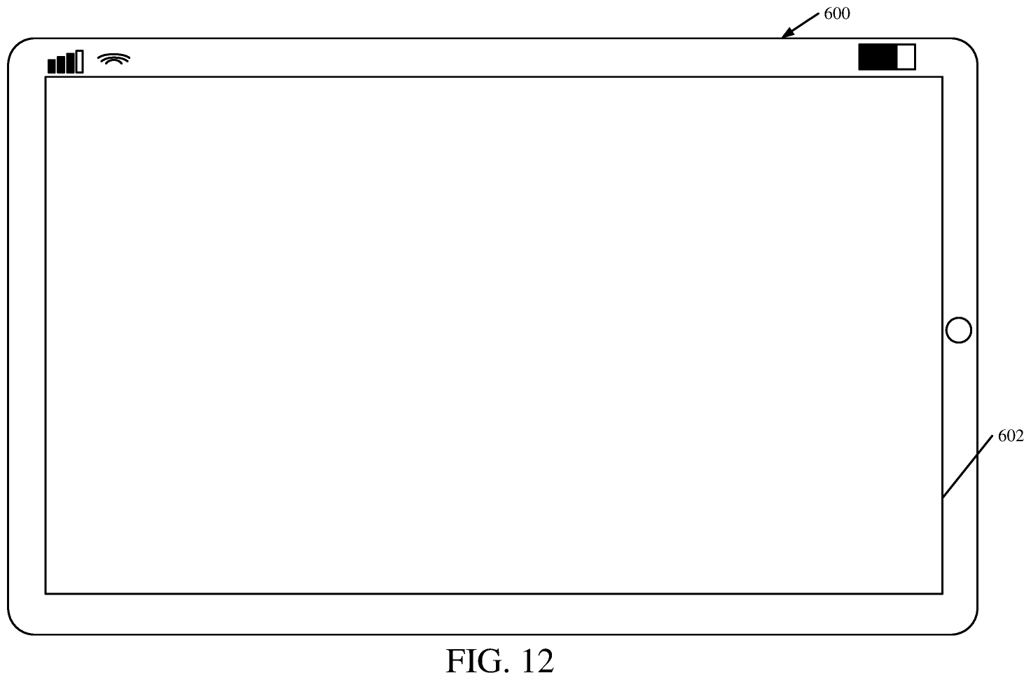

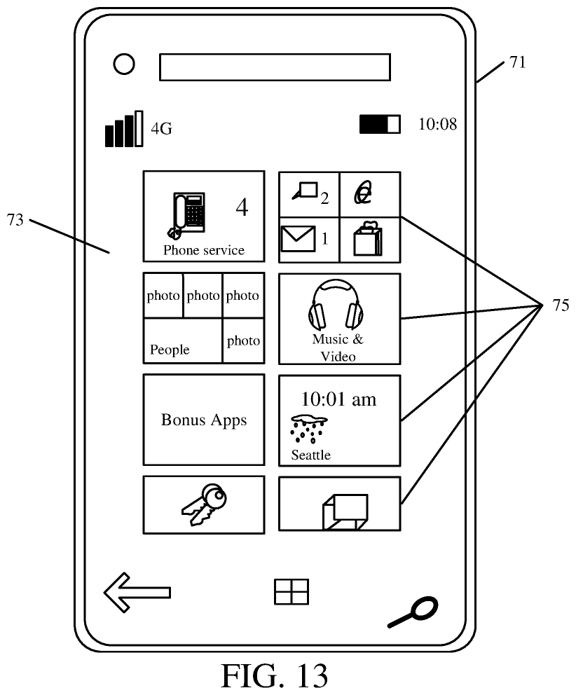

FIG. 11 is a simplified block diagram of one illustrative example of a handheld or mobile computing device that can be used as a user's or client's hand held device 16, in which the present system (or parts of it) can be deployed. FIGS. 12-13 are examples of handheld or mobile devices.

FIG. 11 provides a general block diagram of the components of a client device 16 that can run components of system 102 or systems 104-106 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as 802.11 and 802.11b (Wi-Fi) protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors from previous FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 12 shows one example in which device 16 is a tablet computer 600. In FIG. 12, computer 600 is shown with user interface display displayed on the display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIG. 13 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

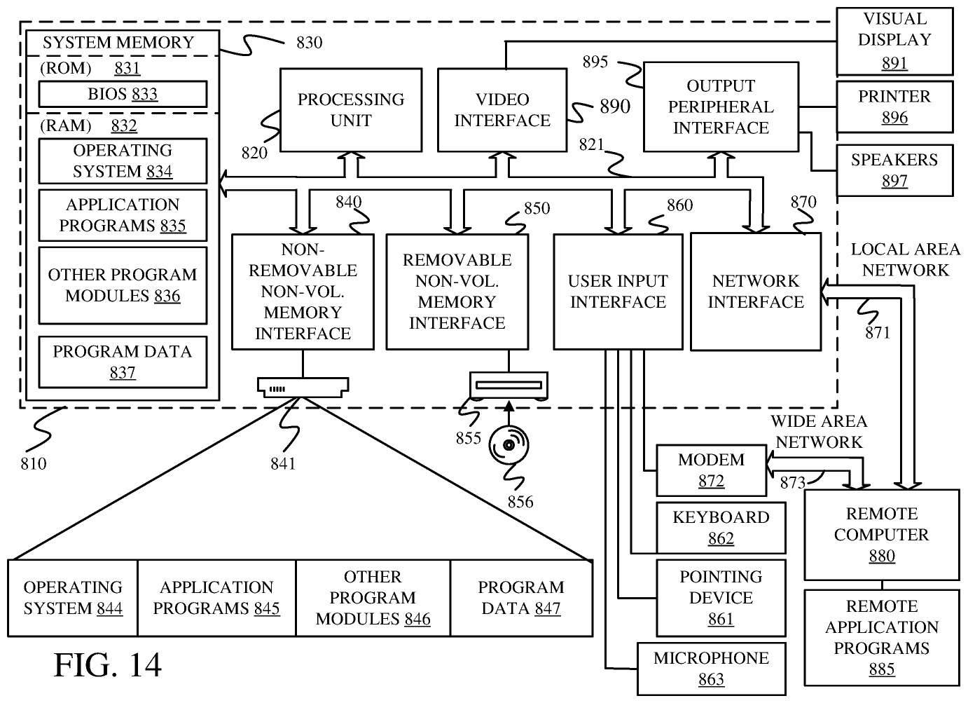

FIG. 14 is one example of a computing environment in which architecture 100, or parts of it, (for example) can be deployed. With reference to FIG. 14, an example system for implementing some embodiments includes a general-purpose computing device in the form of a computer 810. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 14.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 14 illustrates operating system 834, application programs 835, other program modules 836, and program data 837.

The computer 810 may also include other removable/non-removable volatile/nonvolatile computer storage media. By way of example only, FIG. 14 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 14, provide storage of computer readable instructions, data structures, program modules and other data for the computer 810. In FIG. 14, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 14 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 14 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a mobile device, comprising:

a user interface display device;

a pinning system that surfaces a pinning actuator on the user interface display device that is actuated by a user to pin an object, corresponding to a document authoring application, to a screen on the user interface display device;

a pinning service interaction agent that surfaces a content selection actuator on the user interface display device that is actuated by the user to select content, from a remotely stored source document authored using the document authoring application, for display on the pinned object and that interacts with a remote pinning service to intermittently refresh the content from the remotely stored source document; and

a content display generator that displays the selected content on the pinned object on the user interface display device.

Example 2 is the mobile device of any or all previous examples wherein the pinning service interaction agent comprises:

a content selection input detector configured to surface the content selection actuator on the user interface display device and detect user interaction with the content selection actuator.

Example 3 is the mobile device of any or all previous examples wherein the pinning service interaction agent comprises:

a content modification input detector configured to detect a content modification user input modifying the content displayed on the pinned object and to send an indication of the modified content to the remote pinning service.

Example 4 is the mobile device of any or all previous examples wherein the pinning service interaction agent comprises:

a visualization selection input detector configured to detect a visualization selection user input identifying a selected visualization through which the selected content is visualized on the pinned object.

Example 5 is the mobile device of any or all previous examples wherein the content display generator is configured to generate a content display indicative of the selected content displayed through the selected visualization on the pinned object.

Example 6 is the mobile device of any or all previous examples wherein the content display generator is configured to display a visualization actuator that is actuated by the user to switch between visualizing the selected content on the pinned object through a first visualization to visualizing the selected content on the pinned object through a second visualization.

Example 7 is the mobile device of any or all previous examples wherein the pinning service interaction agent comprises:

visualization-specific interaction logic configured to detect user inputs and conduct visualization-specific functions based on the detected user inputs and the selected visualization.

Example 8 is a computing system, comprising:

an application interaction system that includes application-specific logic that controls a document authoring application;

pinned content identifying logic that receives an indication of a content selection input from a mobile device indicative of a portion of content in a document that is selected by a user for rendering on an object pinned to a screen of the mobile device;

content copying logic that copies the selected content from the document to a pinned content store; and

synchronization logic that synchronizes the selected content between the document and the pinned content store and that intermittently sends synchronized content to the mobile device for rendering on the pinned object.

Example 9 is the computing system of any or all previous examples wherein the application-specific logic comprises:

manipulation logic configured to receive the user selection input and manipulate the document using the document authoring logic based on the user selection input.

Example 10 is the computing system of any or all previous examples wherein the synchronization logic comprises:

source-to-mobile device synchronization logic configured to synchronize changes in the selected content, from the document to the pinned object on the mobile device.

Example 11 is the computing system of any or all previous examples wherein the synchronization logic comprises:

modification merging logic configured to receive modifications to the selected content, made on the mobile device, and merge the changes to the document.

Example 12 is a method of controlling a mobile device, comprising:

surfacing a pinning actuator on a user interface display device;

detecting actuation of the pinning actuator to pin an object, corresponding to a document authoring application, to a screen on the user interface display device;

surfacing a content selection actuator on the user interface display device

detecting actuation of the content selection actuator to select content, from a remotely stored source document authored using the document authoring application, for display on the pinned object;

interacting with a remote pinning service to intermittently refresh the content from the remotely stored source document; and

displaying the selected content on the pinned object on the user interface display device.

Example 13 is the method of any or all previous examples and further comprising:

detecting a content modification user input modifying the content displayed on the pinned object.

Example 14 is the method of any or all previous examples and further comprising:

sending an indication of the modified content to the remote pinning service.

Example 15 is the method of any or all previous examples and further comprising:

detecting a visualization selection user input identifying a selected visualization through which the selected content is visualized on the pinned object.

Example 16 is the method of any or all previous examples wherein displaying comprises:

generate a content display indicative of the selected content displayed through the selected visualization on the pinned object.

Example 17 is the method of any or all previous examples wherein displaying comprises:

displaying a visualization actuator; and

detecting actuation of the visualization selection actuator to switch between visualizing the selected content on the pinned object through a first visualization to visualizing the selected content on the pinned object through a second visualization.

Example 18 is the method of any or all previous examples wherein displaying comprises:

generating a display to switch between visualizing the selected content on the pinned object through a first visualization to visualizing the selected content on the pinned object through a second visualization based on the detected actuation of the visualization selection actuator.

Example 19 is the method of any or all previous examples and further comprising:

detecting user actuation of a visualization-specific actuator; and

performing visualization-specific functions based on the detected user actuation and the selected visualization.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A mobile device, comprising:
a user interface display device;
a pinning system that surfaces a pinning actuator on the user interface display device that is actuated by a user to pin an object, corresponding to a document authoring application, to a screen on the user interface display device;
a pinning service interaction agent that surfaces a content selection actuator on the user interface display device that is actuated by the user to select content, from a remotely stored source document authored using the document authoring application, for display on the pinned object and that interacts with a remote pinning service to intermittently refresh the content from the remotely stored source document; and
a content display generator that displays the selected content on the pinned object on the user interface display device.

2. The mobile device of claim 1 wherein the pinning service interaction agent comprises:
a content selection input detector configured to surface the content selection actuator on the user interface display device and detect user interaction with the content selection actuator.

3. The mobile device of claim 2 wherein the pinning service interaction agent comprises:
a content modification input detector configured to detect a content modification user input modifying the content displayed on the pinned object and to send an indication of the modified content to the remote pinning service.

4. The mobile device of claim 3 wherein the pinning service interaction agent comprises:
a visualization selection input detector configured to detect a visualization selection user input identifying a selected visualization through which the selected content is visualized on the pinned object.

5. The mobile device of claim 4 wherein the content display generator is configured to generate a content display indicative of the selected content displayed through the selected visualization on the pinned object.

6. The mobile device of claim 5 wherein the content display generator is configured to display a visualization actuator that is actuated by the user to switch between visualizing the selected content on the pinned object through a first visualization to visualizing the selected content on the pinned object through a second visualization.

7. The mobile device of claim 6 wherein the pinning service interaction agent comprises:
visualization-specific interaction logic configured to detect user inputs and conduct visualization-specific functions based on the detected user inputs and the selected visualization.

8. A computing system, comprising:
an application interaction system that includes application-specific logic that controls a document authoring application;
pinned content identifying logic that receives an indication of a content selection input from a mobile device indicative of a portion of content in a document that is selected by a user for rendering on an object pinned to a screen of the mobile device;
content copying logic that copies the selected content from the document to a pinned content store; and
synchronization logic that synchronizes the selected content between the document and the pinned content store and that intermittently sends synchronized content to the mobile device for rendering on the pinned object.

9. The computing system of claim 8 wherein the application-specific logic comprises:
manipulation logic configured to receive the user selection input and manipulate the document using the document authoring logic based on the user selection input.

10. The computing system of claim 9 wherein the synchronization logic comprises:
source-to-mobile device synchronization logic configured to synchronize changes in the selected content, from the document to the pinned object on the mobile device.

11. The computing system of claim 10 wherein the synchronization logic comprises:
modification merging logic configured to receive modifications to the selected content, made on the mobile device, and merge the changes to the document.

12. A method of controlling a mobile device, comprising:
surfacing a pinning actuator on a user interface display device;
detecting actuation of the pinning actuator to pin an object, corresponding to a document authoring application, to a screen on the user interface display device;
surfacing a content selection actuator on the user interface display device
detecting actuation of the content selection actuator to select content, from a remotely stored source document authored using the document authoring application, for display on the pinned object;
interacting with a remote pinning service to intermittently refresh the content from the remotely stored source document; and
displaying the selected content on the pinned object on the user interface display device.

13. The method of claim 12 and further comprising:
detecting a content modification user input modifying the content displayed on the pinned object.

14. The method of claim 13 and further comprising:
sending an indication of the modified content to the remote pinning service.

15. The method of claim 14 and further comprising:
detecting a visualization selection user input identifying a selected visualization through which the selected content is visualized on the pinned object.

16. The method of claim 15 wherein displaying comprises:
generate a content display indicative of the selected content displayed through the selected visualization on the pinned object.

17. The method of claim 16 wherein displaying comprises:
displaying a visualization actuator; and
detecting actuation of the visualization selection actuator to switch between visualizing the selected content on the pinned object through a first visualization to visualizing the selected content on the pinned object through a second visualization.

18. The method of claim 17 wherein displaying comprises:
generating a display to switch between visualizing the selected content on the pinned object through a first visualization to visualizing the selected content on the pinned object through a second visualization based on the detected actuation of the visualization selection actuator.

19. The method of claim 18 and further comprising:
detecting user actuation of a visualization-specific actuator; and
performing visualization-specific functions based on the detected user actuation and the selected visualization.
